(19) United States
(12) Patent Application Publication
(10) Pub. No.: US 2013/0335738 A1
(43) Pub. Date: Dec. 19, 2013

(54) INTEGRATED OBJECTIVE GRATING CAMERA SYSTEM FOR SPECTROSCOPY

(71) Applicant: Thomas Richard Field, Seattle, WA (US)

(72) Inventor: Thomas Richard Field, Seattle, WA (US)

(21) Appl. No.: 13/873,407

(22) Filed: Apr. 30, 2013

Related U.S. Application Data
(60) Provisional application No. 61/659,108, filed on Jun. 13, 2012.

(51) Int. Cl. G01J 3/18

(52) U.S. Cl. CPC G01J 3/18
USPC 356/328

(57) ABSTRACT

A system for a fix-positioned camera with an internal diffraction grating for classroom and retail applications that is simple to use and inexpensive, as described in this disclosure. The fix-positioned camera system with an internal diffraction grating having a front cover, a rear cover connected to the front cover, a first glass pressure plate affixed to the front cover, a transmission diffraction grating affixed to the first glass pressure plate, a second glass pressure plate affixed to the transmission diffraction grating, a compression O-ring attached to the second glass pressure plate, and a retention block connected to the compression O-ring.

### FIELD OF THE INVENTION

The present invention relates to spectrometers and more specifically to a fix-positioned camera with an internal diffraction grating for classroom and retail applications that is simple to use and inexpensive.

### BACKGROUND

Spectroscopy is the science of splitting light into its component parts (as a rainbow) and then studying the variations in the rainbow, revealing physical properties of the light source and intervening objects. Spectroscopy is the backbone of astronomical research and is also used extensively in the biosciences, including pharmaceuticals.

Until now, there has not been a way to inexpensively manufacture a device that would allow students or other non-scientific users to extract the spectrum from a light source in a way that allows of scientific study. Classrooms have had no easy or inexpensive way to study spectra. They have mostly relied on handing out pieces of diffraction grating foil (or cardboard “rainbow glasses”) and having students look at gas tubes or other bright objects.

There many different types of spectrometers available commercially. However, these devices are either too expensive for schools and consumers or are too complicated to use. Most require slit adjustments, have limited sensitivity and lamp calibrations that make the currently available devices unacceptable for classroom work or for consumer applications. For example, the educational spectroscope from Edmund Scientific found at http://www.edmundoptics.com/testing-targets/spectrometers/educational-spectroscope/1661, is fairly low cost, but allows only visual observation without any software and uses a slit that is difficult to explain and use for a classroom setting. The pocket spectroscope found at http://www.teachersource.com/product/pocket-spectroscope/light-color, despite being portable, suffers from the same issues as the educational spectroscope above. The Red Tide Spectrometer found at http://www.oceanoptics.com/products/usb650.asp requires the use of a slit to form proper spectra. Additionally, this device requires the use of a light source or sample system adding to the overall cost. Separate software is also required to operate the spectrometer again adding to the costs. When this system is finally complete for use in a classroom, the cost is well over $3,000.00 per unit. With shrinking educational budgets, this device is out of the reach of all but the richest schools.

Therefore, there is a need for a fix-positioned camera with an internal diffraction grating for classroom and retail applications that is simple to use and inexpensive.

### BRIEF DESCRIPTION OF THE DRAWINGS

These and other features, aspects and advantages of the present invention will become better understood with regard to the following description, appended claims, and accompanying figures where:

FIG. 1 is an exploded view of a fix-positioned camera with an internal diffraction grating according to one embodiment;

FIG. 2 is a diagram a of a single camera board useful for the system of FIG. 1;

and

FIG. 3 is a diagram of a method of using the system of FIG. 1.

### DETAILED DESCRIPTION

This invention introduces a comprehensive and inexpensive solution to the problems that exist today. The fix-positioned camera with an internal diffraction grating can be used for both classroom and retail applications. For example, unlike the prior art devices described above, and high-end commercial spectroscopes, this invention is a low resolution, slit-less device. This allows the entire spectrum to be viewed, including the “zero-order” source. This device uses a single initial calibration and then spectra of other objects can be calibrated using the known (0 Å angstrom) source. Therefore, no internal calibration lamp is necessary. This simplicity provides maximum use in educational environments with minimal setup time.

Variations of this device can be used by the general consuming public for a variety of home uses, such as, for example, maintaining proper light balance in exotic fish tanks by analyzing the spectra of the lamps used to light the water. Plants in these tanks require specific energy distribution. An easy-to-use device such as described herein, would allow owners of these lights to measure their spectral distribution to determine if it's time to replace the lights.

Additionally, unlike the devices described above, this device comes complete with real-time spectroscopy software. The software is described in U.S. patent application Ser. No. 13/310,185, titled “A Real Time Spectroscopy Processing And Analysis System” by Tom Field, which is hereby incorporated in its entirety by reference. This complete package at a lower price point than many of the available options above makes this device ideally suited for both educators and consumers alike.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

Various embodiments provide a system and device for a fix-positioned camera with an internal diffraction grating for classroom and retail applications that is simple to use and inexpensive. The system and method will now be disclosed in detail.

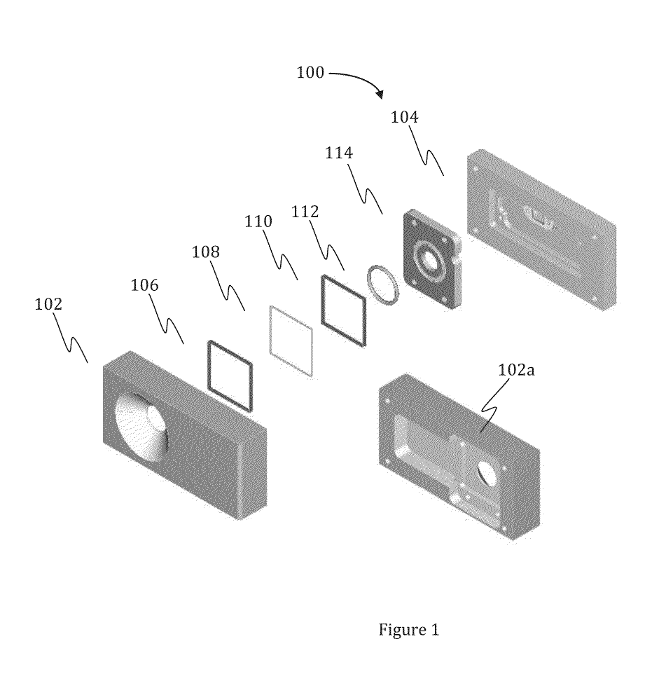

Referring now to FIG. 1, there is shown an exploded view of a fix-positioned camera 100 with an internal diffraction grating according to one embodiment. As can be seen, the device comprises a front cover 102, a rear cover 104, a first glass pressure plate 106, a transmission diffraction grating 108, a second glass pressure plate 110, a compression O-ring 112, and a retention block 114. The front cover 102 comprises an inverse conic section which gives a wide field of view while reducing reflections from the side. The first glass pressure plate 106 and the second glass pressure plate 110, protect the transmission diffraction grating 108 edges sandwiched in between. This sandwich comprising the transmission diffraction grating 108 is placed in proximity to the inverse conic section. The compression O-ring 112 is placed between the transmission diffraction grating 108 sandwich and the retention block 114 to maintain a seal between the nonelectrical parts and the electrical components that are placed within the back cover 104. Additionally, the O-ring 112 is used to accommodate variations in thickness of the glass pressure plates 106 and 110 and the diffraction grating 108. The O-ring 112 applies equal pressure to the glass/diffraction grating 108/glass assembly 106 and 108. This allows the construction use inexpensive glass and diffraction gratings 108 that vary in thickness. Although this description uses and O-ring 112, there are many other means to accomplish this task as will be appreciated by those with skill in the art with reference to this disclosure. For example, the device could comprise soft tape, elastic tape or spring-loaded clips among others.

This configuration is known as an “objective grating” because the grating 108 is in front of the objective lens. The objective grating 108 has the advantage that the amount the spectrum is dispersed is independent of the distance between the grating 108 and the sensor, depending on the focal length of the camera and the spacing of the grooves (lines/mm) of the grating 108. This configuration does not require a slit or other collimating lens. This invention improves upon currently available objective grating devices by providing an easy to mass produce, inexpensive components device where the grating is held firmly and is secure from accidental misalignment and is aligned in-place.

The back cover 104 comprises an opening for a camera 200 and an opening for a camera connection. The camera 200 can be placed in-line with the transmission diffraction grating and the inverse conic opening of the front cover. The connection to the camera 200 can be by any known means including, but not limited to, USB, FireWire, optical or network among others. As will be understood by those with skill in the art with reference to this disclosure.

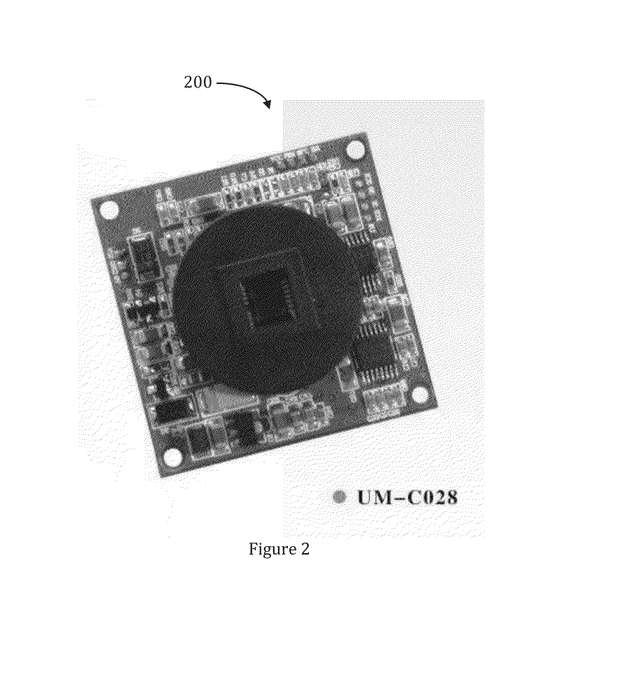

Referring now to FIG. 2, this configuration allows us to use an inexpensive, internally mounted webcam camera 200 (single-board, USB camera with auto-focus) with no complicated or ad-hoc grating mounting, making a complete turn-key spectroscope. Student and users can not touch or in any other way affect the grating 108 since it is inside the fixed position camera 100, and protected by glass 106 and 110.

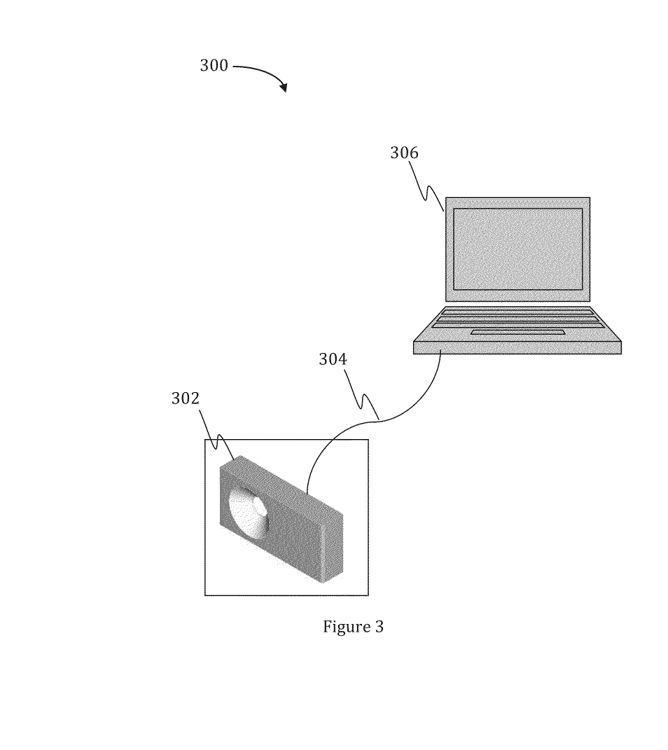

Referring now to FIG. 3, there is shown a diagram of a method of using the system 100, according to one embodiment. As can be seen, a low resolution, slit-less device for viewing spectra including “zero-order” sources is provided. Then, a single initial calibration using a 0 Å angstrom source is performed. Next, the slit-less device is connected to a computer using a connector. Preferably, the connector is a USB cable. Then, an object is placed in front of the objective lens. Finally, spectra from the object are detected using real-time spectroscopy software executing on the computer.

What has been described is a new and improved system for a fix-positioned camera with an internal diffraction grating for classroom and retail applications that is simple to use and inexpensive, overcoming the limitations and disadvantages inherent in the related art.

Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

What is claimed is:

1. A fix-positioned camera system with an internal diffraction grating, the system comprising:
a) a front cover;
b) a rear cover connected to the front cover;
c) a first glass pressure plate affixed to the front cover;
d) a transmission diffraction grating affixed to the first glass pressure plate;
e) a second glass pressure plate affixed to the transmission diffraction grating;
f) a compression O-ring attached to the second glass pressure plate; and
g) a retention block connected to the compression O-ring.

2. The system of claim 1, where the front cover comprises an inverse conic section that provides a wide field of view while reducing side reflections.

3. The system of claim 1, where the transmission diffraction grating is in-between the first glass pressure plate and the second glass pressure plate forming a transmission diffraction grating sandwich to protect the transmission diffraction grating edges.

4. The system of claim 3, where the transmission diffraction grating sandwich is placed in proximity to the inverse conic section.

5. The system of claim 4, where the compression O-ring is placed between the transmission diffraction grating sandwich and the retention block to maintain a seal between the nonelectrical parts and the electrical components placed within the back cover.

6. The system of claim 5, where the O-ring can be used to accommodate variations in thickness of the transmission diffraction grating sandwich.

7. The system of claim 4, where an adjustment seal selected from the group consisting of soft tape, elastic tape, and spring-loaded is placed between the transmission diffraction grating sandwich and the retention block to maintain a seal between the nonelectrical parts and the electrical components placed within the back cover.

8. The system of claim 1, where the back cover comprises an opening for a camera and an opening for a camera connection.

9. The system of claim 8, where the camera can be placed in-line with the transmission diffraction grating and the inverse conic opening of the front cover.

10. The system of claim 9, where the camera connection is selected from the group consisting of USB, FireWire, optical and network.

11. The system of claim 9, where the camera connection is USB.

12. A method for using a fix-positioned camera system with an internal diffraction grating, the method comprising the steps of:
a) providing a low resolution, slit-less device for viewing spectra including “zero-order” sources;
b) performing a single initial calibration using a 0 Å angstrom source;
c) connecting the slit-less device to a computer using a connector;
c) placing an object in front of the objective lens; and
c) detecting spectra using real-time spectroscopy software executing on the computer.
